(19) United States
(12) Patent Application Publication
(10) Pub. No.: US 2004/0212307 A1
(43) Pub. Date: Oct. 28, 2004

(54) Flat lamp

(76) Inventors: Yui-Shin Fran, Hsinchu (TW); Lai-Cheng Chen, Hsinchu (TW); Jui-Hsia Chen, Yulin Hsien (TW); Jer-Shien Yang, Chiayi Hsien (TW); Chien-Chung Wu, Taipei (TW); Cheng-Yi Chang, Hsinchu (TW)

Correspondence Address: BIRCH STEWART KOLASCH & BIRCH, PO BOX 747, FALLS CHURCH, VA, 22040-0747, US

(21) Appl. No.: 10/790,788

(22) Filed: Mar. 3, 2004

(30) Foreign Application Priority Data
Apr. 24, 2003 (TW) 092206519

(51) Int. Cl. H01J 17/18; H01J 61/36

(52) U.S. Cl. 313/623; 313/634

(57) ABSTRACT

A flat lamp. The flat lamp comprises an upper glass plate, a bottom glass plate, at least one glass sidewall, two long electrodes, two front glass sleeves and two rear glass sleeves. The upper glass plate, the bottom glass plate and the glass sidewalls form a closed space. The two long electrodes are parallel and extend through the front glass sleeves into the closed space. Support from the rear glass sleeve prevents electrode bending.

### BACKGROUND OF THE INVENTION

1. Field of the Invention

The present invention relates to a flat lamp structure.

2. Description of the Related Art

Cold Cathode Flat Fluorescent Lamps (flat lamp hereinafter) provide flat light source with less weight and thin profile. Planar or striped electrodes are disposed in a light box filled with inert gas and mercury vapor. The mercury vapor molecules are ionized to plasma state and emit ultraviolet (UV) rays to collide with a fluorescent layer on the walls of the light box, and visible light is emitted. Due to its high brightness and long service life, flat lamp is used as backlight module in LCD monitors as well as a light source in signboards or special guide lighting.

As shown in FIG. 1, a conventional flat lamp comprises an upper glass plate (not shown), a bottom glass plate 101 and four glass sidewalls 102, 103, 104, 105 to form a closed space. Gas tube 108 connected to a pipeline (not shown) evacuates the space and fills inert gas and mercury vapor. Two parallel long electrodes 106, 107 extend into the space through the sidewall 102. When voltage is applied to the electrodes 106, 107, one of the electrodes 106, 107 emits electrons and excites the mercury vapor to emit UV rays. When the UV rays collide with the fluorescence layer, and visible light is emitted.

When the size of the flat lamp is enlarged (over 5 inches), the length of the electrodes exceeds 10 cm. Therefore, the two electrodes will bend and approach each other over long use or overloaded voltage, the light is finally only emitted at the position of shortest distance there between. Bending occurs by the front (right) end being only secured on the sidewall with glass gel in advance, and if the rear (left) end is also to be secured as well, the electrodes will be elongated during glass gel heating at 450° C. to secure the rear end. This can also result in rupture of the sidewalls or the glass plates. The typical resolution is to suspend the rear end; however this also causes bending.

### SUMMARY OF THE INVENTION

Accordingly, an object of the invention is to provide a flat lamp that avoids bending and rupture problems occurring in conventional flat lamp technology.

The flat lamp in the invention comprises an upper glass plate, a bottom glass plate, at least one glass sidewall, two long electrodes, two front glass sleeves and two rear glass sleeves. The upper glass plate, the bottom glass plate and the glass sidewalls form a closed space. The two long electrodes are parallel and extend through the front glass sleeves into the closed space.

The front and rear glass sleeves are secured on the sidewalls. The rear glass sleeve holds one end of the electrode in the closed space so that elongation of the electrodes from heating will not result in bending thereof.

The end surface of the electrode and the rear glass sleeve are spaced apart. Elongation of the electrodes due to heating is less than the sum of the linear heating expansion of the rear glass sleeve and the spacing. Thus, the rupture of the glass sidewalls and glass plates will be avoided.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional structure of flat lamp as referenced in the Prior Art;

FIG. 2 is a schematic view of an embodiment of the invention;

FIG. 3 is a schematic view of an electrode assembly of the invention; and

FIG. 4 is a sectional view of the electrode and the rear glass sleeve of the invention.

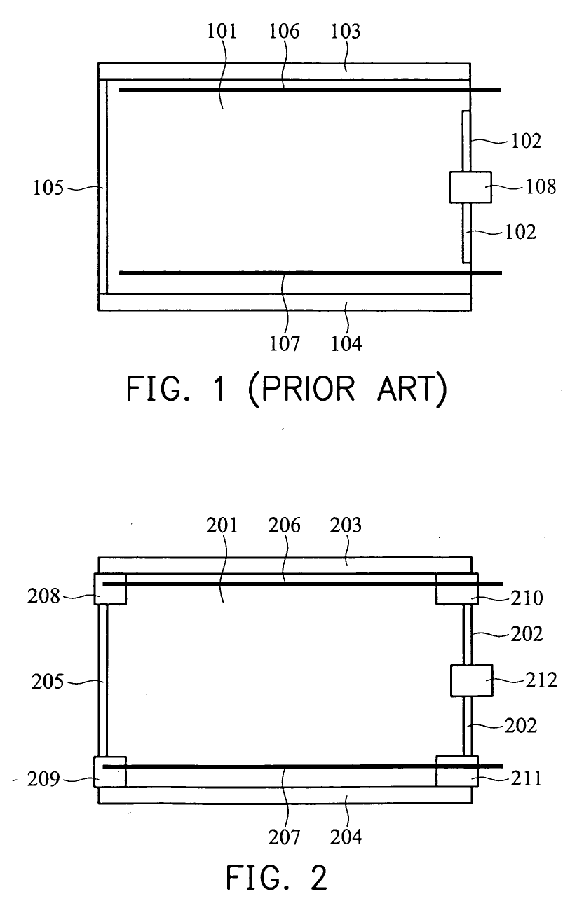

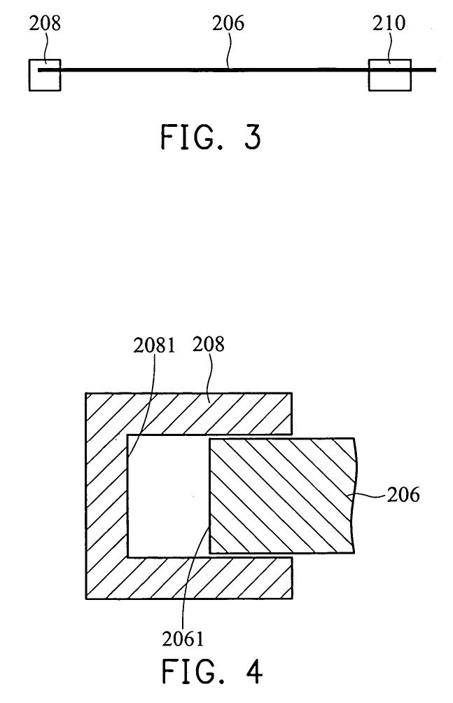

### DETAILED DESCRIPTION OF THE INVENTION

Referring to FIGS. 2 & 3, an upper glass plate (not shown), a bottom glass plate 201 and four glass sidewalls 202, 203, 204 and 205 form a closed space. Two front glass sleeves 210, 211 are secured on the bottom glass between the sidewalls 202, 203 and 204 and two rear glass sleeves 208, 209 are secured on the bottom glass between the sidewalls 205, 203 and 204. The rear of the electrode 206 is supported by the rear glass sleeve 208, and the front end thereof extends outward through the front glass sleeve 210. The rear of the electrode 207 is supported by the rear glass sleeve 209, and the front end thereof extends outward through the front glass sleeve 211. Exhaust tube 212 is secured on the middle portion of the sidewall 202 to evacuate the closed space and supply gas. When the electrodes 206, 207 elongate due to heating, the support of the rear glass sleeve 208, 209 prevents the bending thereof.

As shown in FIG. 4, when the electrode 206 is fixed by the rear glass sleeve 208, the end surface 2061 of the electrode 206 and the inner surface 2081 of the rear glass sleeve 208 are spaced apart. The elongating of the electrode 206 due to heating is less than the sum of the linear expansion of the rear glass sleeve 208 and the distance there between. When the electrodes 206, 207 elongate due to heating, the rupture of the glass plates and sidewalls is, however, prevented by the spacing.

The glass sleeves 208, 209, 210 and 211 can be secured on the bottom glass between the sidewalls 202, 205, 203 and 204 by means of glass gel. The glass sleeves can be melted directly to secure the electrodes 206, 207 as well as seal the entire closed space at the same time, or glass gel can be applied to the glass sleeves and filled therein followed by heating at 450° C. to melt the glass gel so as to secure the electrodes and seal the entire closed space as well.

Two methods of assembly for the structure of the flat lamp according to the invention are described as follows.

In one method, the bottom glass plate, the sidewalls and the front & rear glass sleeves are assembled, followed by heating to integrate the assembly. The electrodes are inserted and the front glass sleeves are sealed with glass gel the upper glass plate is placed thereon; followed by finally heating the assembly again.

The other method comprises assembling the bottom glass plate, the sidewalls and the front & rear glass sleeves, followed by heating to integrate the assembly. The electrodes are inserted and the front glass sleeves are sealed with melting the front glass sleeves; heating the assembly, placing an upper glass plate thereon and finally heating the assembly again.

The electrodes 206, 207 can be rectangular or linear depending on requirements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flat lamp, comprising:
an upper glass plate;
a bottom glass plate;
at least one sidewall to form a closed space with the upper glass plate and the bottom glass plate;
at least two electrodes parallel extending into the closed space;
at least two rear sleeves positioned in the closed space to support the electrodes; and
at least two front glass sleeves secured on the bottom glass between sidewalls, wherein the electrodes extend from the closed space outward through the front glass sleeves.

2. The flat lamp as claimed in claim 1, wherein the end surface of the electrode to the rear glass sleeve are spaced apart.

3. The flat lamp as claimed in claim 2, wherein the elongation of the electrodes due to heating is less than the sum of the linear heating expansion of the rear glass sleeve and the spacing.

4. The flat lamp as claimed in claim 1, wherein the rear glass sleeve is secured on the bottom glass between the sidewalls, and the electrode is held therein.

5. The flat lamp as claimed in claim 1, wherein the front glass sleeve is secured on the bottom glass plate and the electrodes are held therein.

6. The flat lamp as claimed in claim 1, wherein the rear glass sleeve is melted to seal the closed space.

7. The flat lamp as claimed in claim 1, wherein the front glass sleeve is melted to secure the electrode and seal the closed space.

8. The flat lamp as claimed in claim 1, wherein the front glass sleeve is bonded to the bottom glass between the sidewalls and the closed space is sealed by means of glass gel.

9. The flat lamp as claimed in claim 1, wherein the electrodes are inserted and secured through the front glass sleeves by melting the front glass sleeves.

10. The flat lamp as claimed in claim 1, wherein the electrodes are inserted and secured through the front glass sleeves by glass gel.
